(19) United States
(12) Patent Application Publication
(10) Pub. No.: US 2011/0047355 A1
(43) Pub. Date: Feb. 24, 2011

(54) Offset Based Register Address Indexing

(75) Inventors: Eric O. Mejdrich, Rochester, MN (US); Adam J. Muff, Rochester, MN (US); Robert A. Shearer, Rochester, MN (US); Matthew R. Tubbs, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 12/546,071

(22) Filed: Aug. 24, 2009

(51) Int. Cl. G06F 9/30

(52) U.S. Cl. 712/208; 712/E09.016; 712/225

(57) ABSTRACT

A circuit arrangement and method support offset based register address indexing, wherein register addresses to be used by an instruction are calculated using offsets to the full target register address, and the offsets are contained in the instruction and occupy less instruction space than the full address widths. An instruction may include at least one offset value that identifies a register address. During decoding of the instruction, an offset and a full target address are retrieved from the instruction, and then a register address is calculated by addition of the offset to the full target address.

### FIELD OF THE INVENTION

The invention is generally related to data processing, and in particular to processor architectures and execution units incorporated therein.

### BACKGROUND OF THE INVENTION

The fundamental task of every computer processor is to execute computer programs. How a processor handles this task, and how computer programs must present themselves to a processor for execution, are governed by both the instruction set architecture (ISA) and the microarchitecture of the processor. An ISA is analogous to a programming model, and relates principally to how instructions in a computer program should be formatted in order to be properly decoded and executed by a processor, although an ISA may also specify other aspects of the processor, such as native data types, registers, addressing modes, memory architecture, interrupt and exception handling, and external I/O. The microarchitecture principally governs lower level details regarding how instructions are decoded and executed, including the constituent parts of the processor (e.g., the types of execution units such as fixed and floating point execution units) and how these interconnect and interoperate to implement the processor's architectural specification.

An ISA typically includes a specification of the format of each type of instruction that is capable of being executed by a particular processor design. Typically, an instruction will be encoded to include an opcode that identifies the type of instruction, as well as one or more operands that identify input and/or output data to be processed by the instruction. In many processor designs, for example Reduced Instruction Set Computer (RISC) and other load-store designs, data is principally manipulated within a set of general purpose registers (GPR's) (often referred to as a “register file”), with load and store instructions used to respectively retrieve input data into GPR's from memory and store result or output data from GPR's and back into memory. Thus, for a majority of the instructions that manipulate data, the instructions specify one or more input or source registers from which input data is retrieved, and an output or destination register to which result data is written.

Instructions are typically defined in an ISA to be a fixed size, e.g., 32 bits or 64 bits in width. While multiple 32 or 64 bit values may be used to specify an instruction, the use of multiple values is undesirable because the multiple values take more time to propagate through the processor and significantly increase design complexity. With these fixed instruction widths, only a limited number of bits are available for use as opcodes and operands.

Each unique instruction type conventionally requires a unique opcode, so in order to support a greater number of instruction types (a continuing need in the industry), additional bits often must be allocated to the opcode portion of an instruction architecture. In some instances, opcodes may be broken into primary and secondary opcodes, with the primary opcode defining an instruction type and the secondary opcode defining a subtype for a particular instruction type; however, even when primary and secondary opcodes are used, both opcodes occupy bit positions in each instruction.

Likewise, a continuing need exists for expanding the number of registers supported by an ISA, since improvements in fabrication technology continue to enable greater numbers of registers to be architected into an integrated circuit, and in general performance improves as the number of registers increases. Each register requires a unique identifier as well, so as the number of registers increases, the number of bit positions in each instruction required to identify all supported registers likewise increases.

As an example, consider a processor architecture that supports 32-bit instructions with 6-bit primary opcode fields, and thus supports a total of 64 types, or classes of instructions. If, for example, it is desirable to implement within this architecture a class of instructions that identifies up to three source registers and a separate destination register from a register file of 64 registers, each operand requires a 6-bit operand field. As such, 6 bits are needed for the primary opcode, 18 bits are needed for the source register addresses and 6 bits are needed for the target register address, leaving only 2 bits for an extended opcode, and allowing for only four possible instructions in this instruction class.

In most instances, however, more instruction types are needed for an architecture to be useful. For instance, an instruction class for performing floating point operations may need instruction types that perform addition, subtraction, multiplication, fused multiply-add operations, division, exponentiation, trigonometric operations, comparison operations, and others.

Conventional attempts have been made to address these limitations. For example, three-source operations may be made destructive, meaning the target and one source address would be implicitly equal, such that one address field in the above example would not be needed, freeing up space for additional extended opcodes. Destructive operations, however, are often not convenient for compilers and software engineers, because often times an extra copy of the source data that would be overwritten by the destructive operation needs to be saved away in a temporary register, which can have potential performance problems in addition to using valuable temporary register space.

Therefore, a significant need continues to exist in the art for a manner of increasing the number and complexity of instructions supported by an instruction set architecture.

### SUMMARY OF THE INVENTION

The invention addresses these and other problems associated with the prior art by utilizing register address offsets from a base register address as a substitute for full source register addresses in the instruction.

Therefore, consistent with one aspect of the invention, a computer system includes a register file for storing and retrieving operands addressed by register addresses, an execution unit for executing instructions that receive source operands from the register file and write results back into the register file, address calculation logic that calculates source and target register addresses to be used by the register file from a base register address and address offsets, and instruction decode logic that decodes instructions and provides the base register address and address offsets to the address calculation logic.

The address calculation logic is configured to calculate the source register addresses by adding each address offset to the base address separately, and provide the source addresses to the register file. The register file is configured to provide operand data to the execution unit in response to receiving the source register addresses.

Consistent with another aspect of the invention, a method is provided for executing instructions in a processor, where, in response to receiving an instruction that contains address offsets in lieu of full source addresses, the source addresses are calculated by adding each individual source address offset to the base address provided in the instruction, to yield all source addresses. The source and target addresses are then provided to the register file such that operand data can be read from the register file that is associated with the source addresses. This operand data is then used to execute the instruction.

These and other advantages and features, which characterize the invention, are set forth in the claims annexed hereto and forming a further part hereof. However, for a better understanding of the invention, and of the advantages and objectives attained through its use, reference should be made to the drawings, and to the accompanying descriptive matter, in which there is described exemplary embodiments of the invention.

### BRIEF DESCRIPTION OF THE DRAWINGS

FIG. 1 is a block diagram of exemplary automated computing machinery including an exemplary computer useful in data processing consistent with embodiments of the present invention.

FIG. 2 is a block diagram illustrating in greater detail an exemplary implementation of the processor in FIG. 1.

FIG. 3 is a block diagram illustrating an exemplary implementation of an auxiliary instruction issue logic from the processor of FIG. 2.

FIG. 4 is a block diagram of an address calculation logic incorporating offset based register address indexing consistent with the invention, and capable of being implemented within the processor of FIG. 2.

FIG. 5 is a flow chart illustrating an exemplary sequence of operations performed by the auxiliary instruction issue logic of FIG. 3 to implement offset based register address indexing consistent with the invention.

FIG. 6 is an illustration of two instruction formats, the first instruction format suitable for execution by an exemplary AXU Auxiliary Execution Unit as shown in FIG. 2, and the second suitable to be executed by an AXU Auxiliary Execution unit consistent with the embodiment shown in FIG. 4.

### DETAILED DESCRIPTION

Embodiments consistent with the invention utilize a register address offset in supported instructions in place of full source register addresses. The register address offset corresponds to a register address that is the sum of the address offset and a base address contained in the instruction. Upon decoding an instruction that supports offset based register address indexing, embodiments consistent with the invention will use the address offset and base address contained in the instruction to add the base address to the source offset to obtain the address that will be used as a source address when executing the supported instruction. It is important to note that register address offsets contained in the instruction are an offset to an address associated with a register file entry, which is distinct from an offset to an address in memory.

The hereinafter described embodiments allow for much greater opcode space in fixed instruction width architectures by using register address offsets that occupy fewer bits than the full source addresses, thereby freeing up more bits in the instruction for opcode space.

Other modifications will become apparent to one of ordinary skill in the art having the benefit of the instant disclosure.

### Hardware and Software Environment

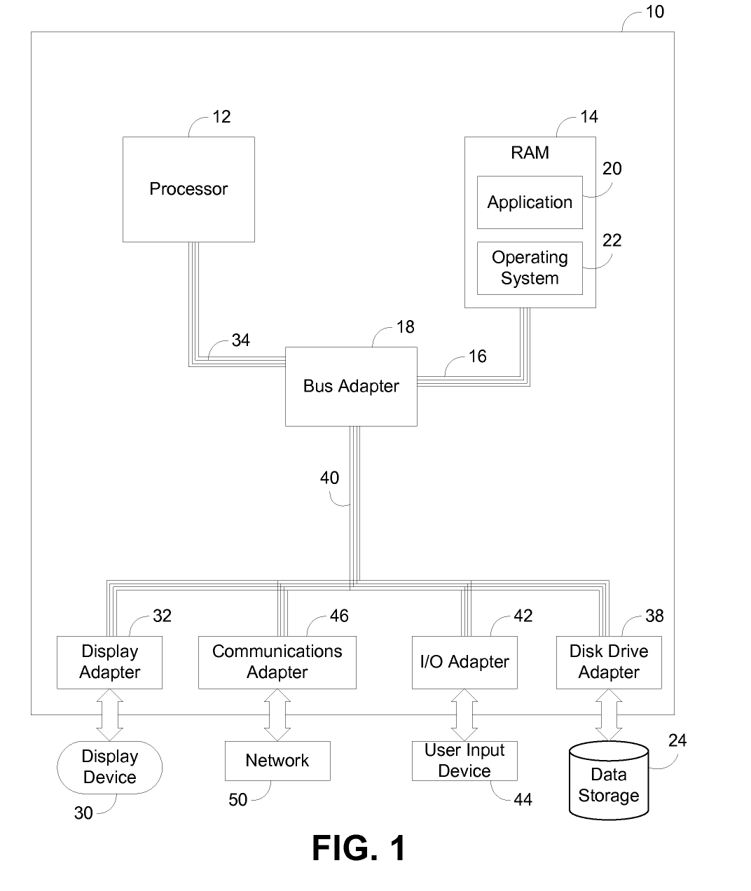

Now turning to the drawings, wherein like numbers denote like parts throughout the several views, FIG. 1 illustrates exemplary automated computing machinery including an exemplary computer 10 useful in data processing consistent with embodiments of the present invention. Computer 10 of FIG. 1 includes at least one computer processor 12 or ‘CPU’ as well as a random access memory 14 (‘RAM’), which is connected through a high speed memory bus 16 and a bus adapter 18 to processor 12 through a processor bus 34.

Stored in RAM 14 is an application 20, a module of user-level computer program instructions for carrying out particular data processing tasks such as, for example, word processing, spreadsheets, database operations, video gaming, stock market simulations, atomic quantum process simulations, or other user-level applications. Also stored in RAM 14 is an operating system 22. Operating systems useful in connection with embodiments of the invention include UNIX™, Linux™, Microsoft Windows XP™, AIX™, IBM's i5/OS™, and others as will occur to those of skill in the art. Operating system 22 and application 20 in the example of FIG. 1 are shown in RAM 14, but many components of such software typically are stored in non-volatile memory also, e.g., on data storage such as a disk drive 24.

Computer 10 of FIG. 1 includes a disk drive adapter 38 coupled through an expansion bus 40 and bus adapter 18 to processor 12 and other components of the computer 10. Disk drive adapter 38 connects non-volatile data storage to the computer 10 in the form of disk drive 24, and may be implemented, for example, using Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

Computer 10 also includes one or more input/output (‘I/O’) adapters 42, which implement user-oriented input/output through, for example, software drivers and computer hardware for controlling input and output to and from from user input devices 44 such as keyboards and mice. In addition, computer 10 includes a communications adapter 46 for data communications with a data communications network 50. Such data communications may be carried out serially through RS-232 connections, through external buses such as a Universal Serial Bus (‘USB’), through data communications networks such as IP data communications networks, and in other ways as will occur to those of skill in the art. Communications adapter 46 implements the hardware level of data communications through which one computer sends data communications to another computer, directly or through a data communications network. Examples of communications adapter 46 suitable for use in computer 10 include but are not limited to modems for wired dial-up communications, Ethernet (IEEE 802.3) adapters for wired data communications network communications, and 802.11 adapters for wireless data communications network communications. Computer 10 also includes a display adapter 32 which facilitates data communication between bus adapter 18 and a display device 30, allowing application 20 to visually present output on display device 30.

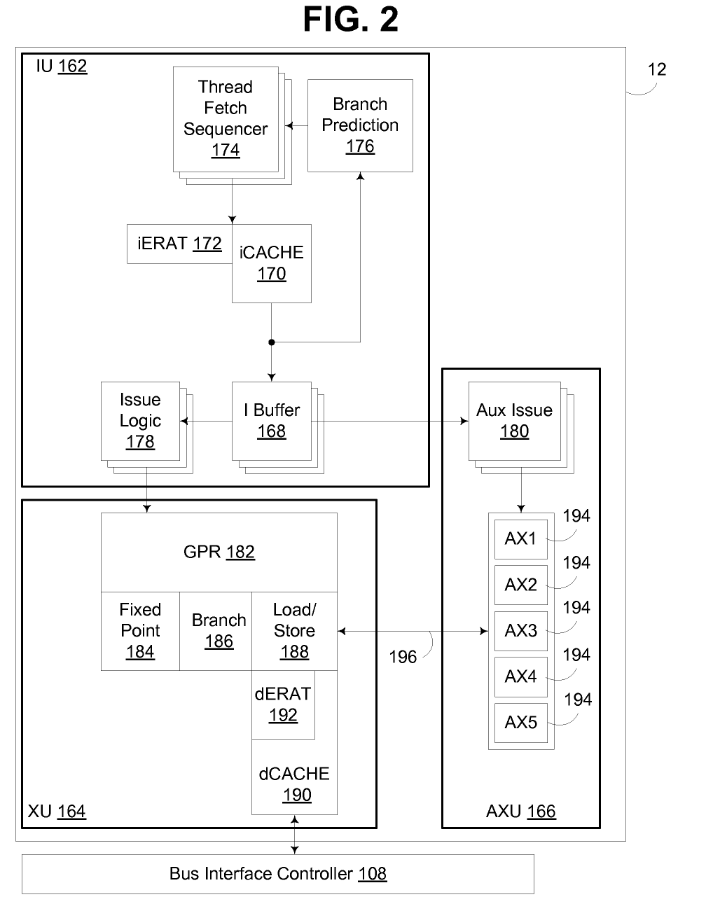

FIG. 2 next illustrates in detail one exemplary implementation of a processor 12 consistent with the invention, implemented as a processing element partitioned into an instruction unit (IU) 162, an execution unit (XU) 164 and an auxiliary execution unit (AXU) 166. In the illustrated implementation, IU 162 includes a plurality of instruction buffers (I Buffer) 168 that receive instructions from an L1 instruction cache (iCACHE) 170. Each instruction buffer 168 is dedicated to one of a plurality, e.g., four, symmetric multithreaded (SMT) hardware threads. An effective-to-real translation unit (iERAT) 172 is coupled to iCACHE 170, and is used to translate instruction fetch requests from a plurality of thread fetch sequencers 174 into real addresses for retrieval of instructions from lower order memory, through a bus interface controller 108. Each thread fetch sequencer 174 is dedicated to a particular hardware thread, and is used to ensure that instructions to be executed by the associated thread is fetched into the iCACHE 170 for dispatch to the appropriate execution unit. As also shown in FIG. 2, instructions fetched into instruction buffer 168 may also be monitored by branch prediction logic 176, which provides hints to each thread fetch sequencer 174 to minimize instruction cache misses resulting from branches in executing threads.

IU 162 also includes a plurality of issue logic blocks 178 and configured to resolve dependencies and control the issue of instructions from instruction buffer 168 to XU 164. In addition, in the illustrated embodiment, a plurality of separate auxiliary instruction issue logic blocks 180 is provided in AXU 166, thus enabling separate instructions to be concurrently issued by different threads to XU 164 and AXU 166. In an alternative embodiment, (not illustrated) auxiliary instruction issue logic 180 may be disposed in IU 162, or may be omitted in its entirety, such that issue logic 178 issues instructions to AXU 166.

XU 164 is implemented as a fixed point execution unit, including a general purpose register array (GPR) 182 coupled to fixed point logic 184, a branch logic 186 and a load/store logic 188. Load/store logic 188 is further coupled to an L1 data cache (dCACHE) 190, with effective to real translation provided by a dERAT logic 192. XU 164 may be configured to implement practically any instruction set, e.g., all or a portion of a 32b or 64b Power™ Architecture instruction set.

AXU 166 operates as an auxiliary execution unit including the auxiliary instruction issue logic 180 along with one or more execution blocks 194. AXU 166 may include any number of execution blocks, and may implement practically any type of execution unit, e.g., a floating point unit, or one or more specialized execution units such as encryption/decryption units, coprocessors, vector processing units, graphics processing units, XML processing units, etc. In the illustrated embodiment, AXU 166 includes a high speed auxiliary interface 196 to XU 164, e.g., to support direct moves between AXU register contents and XU register contents.

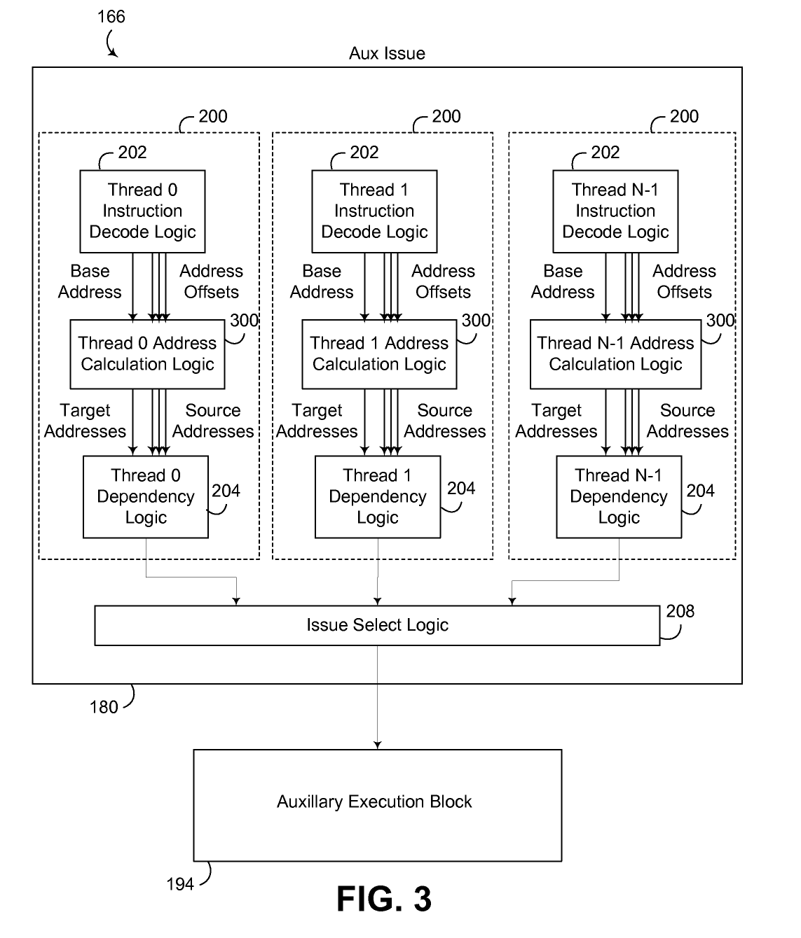

FIG. 3 illustrates in further detail an exemplary AXU 166 suitable for implementation inside of processor 12 in FIG. 2. AXU 166 is configured with auxiliary instruction issue logic 180, which is configured to select fair issuance of instructions from multiple threads using an issue select logic 208, which in turn issues instructions from the selected thread to an auxiliary execution block 194. AXU 166 is also configured to decode instructions for each thread with an instruction decode logic 202. Instruction decode logic 202 decodes instructions from its associated thread to determine if the current instruction supports offset based register address indexing consistent with the invention. In addition, instruction decode logic 202 obtains a base address and one or more address offsets from the instruction and provides them to address calculation logic 300. Address calculation logic 300 is configured to calculate the target address and source addresses from the base address and the address offsets, and provide the target and source addresses to dependency logic 204. Dependency logic 204 is configured to resolve dependencies between instructions, and pass target and source addresses to issue select logic 208.

In a multithreaded design consistent with the invention, one group 200 of instruction decode logic 202, address calculation logic 300, and dependency logic 204 exists for each thread in the design. Alternatively, other embodiments may be implemented in a single threaded design, where only a single thread is issued to one group 200 of instruction decode logic 202, address calculation logic 300, and dependency logic 204, and only one group 200 exists in the design.

### Register Address Offset Based Address Indexing in an Issue Unit

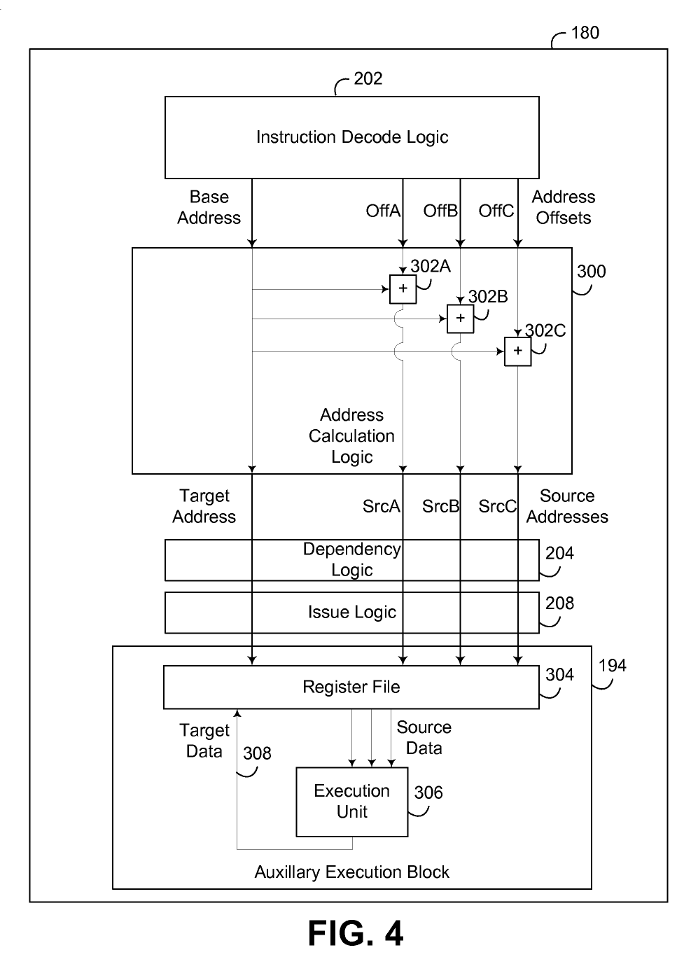

FIG. 4 illustrates in further detail auxiliary instruction issue logic 180, previously shown in FIG. 3. Instruction decode logic 202 obtains a base address and one or more address offsets from the instruction and provides them to an address calculation logic 300. Address calculation logic 300 is configured to calculate the target address and source addresses from the base address and the address offsets, and provide the target and source addresses to dependency logic 204. Address calculation logic 300 utilizes adders 302A, 302B and 302C to add the address offsets to the base address to obtain the respective source addresses (shown in FIG. 4 as SrcA, SrcB and SrcC). Dependency logic 204 is configured to resolve dependencies between instructions, and pass target and source addresses to issue logic 208, which then issues the target and source addresses to register file 304. Register file 304 is configured to write target data from executed instructions from execution unit 306 into a register file entry associated with the target address provided by address calculation logic 300. Register file 304 is partitioned by thread such that one thread may not read to or write from a partition of another thread. Register file 304 is further configured to read source data from register file entries associated with the source addresses provided by address calculation logic 300, and provide the source data to execution unit 306 for use in execution of the instruction.

Auxiliary execution block 194 includes a register file 304 coupled to an execution unit 306. Register file 304 includes an array of registers, (not pictured) each of which are accessed by a unique address. For example, register file 304 may be implemented to support 64 registers, each accessed by a unique 6 bit address. It will be appreciated that different numbers of registers may be supported in different embodiments.

Register file 304, in response to receiving source register addresses from address calculation logic 300, will read operand data contained in the register file entries associated with the source register addresses and provide the required operand data to the execution unit 306.

Execution unit 306, in response to operand data received from register file 304, performs mathematical, logical or other operations on one or more source operands retrieved from selected registers in register file 304. For example, execution unit 306 receives a source operand from register file 304, and may store a result data back into register file 304, e.g., in the form of target data 308 written to a register in the register file associated with the target address from address calculation logic 300.

Execution unit 306 may be implemented as a number of different types of execution units, e.g., floating point units, fixed point units, or specialized execution units such as graphics processing units, encryption/decryption units, coprocessors, XML processing units, etc, and still remain within the scope and spirit of the present invention.

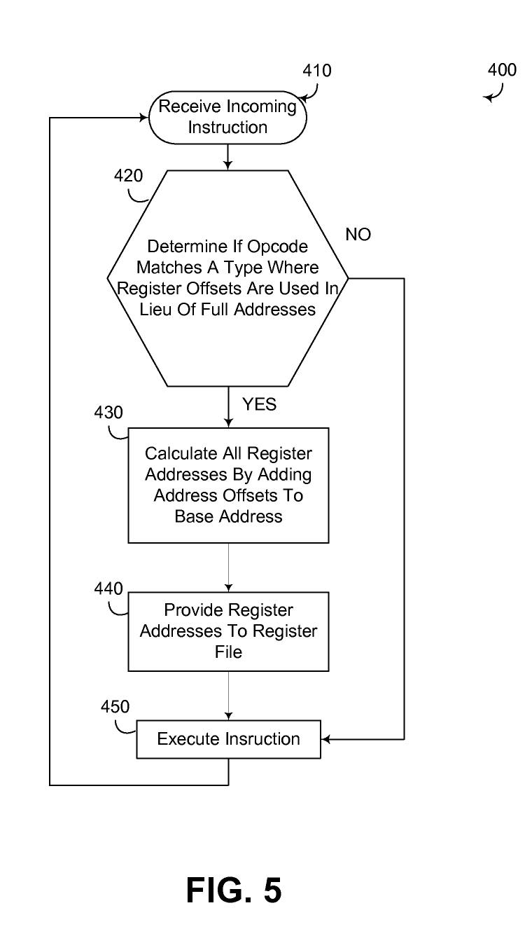

FIG. 5 illustrates a method 400 outlining a sequence of operations performed by auxiliary execution unit 166 when processing instruction from an instruction stream, and supporting offset based register address indexing consistent with the invention. With this sequence of operations, the instruction is received in block 410. Control then passes to block 420, where a determination is made as to whether the instruction type of the incoming instruction is of the type that contains any address offsets in place of full register addresses. If not, control passes to block 450, where the instruction is executed, and control passes back to block 410 to receive the next incoming instruction in the instruction stream.

If a determination is made in block 420 that the current instruction is of the type that contains address offsets in lieu of full addresses, then control passes to block 430, where all register addresses are calculated by adding each address offset with a base address to yield each full register address. Control then passes to block 440, where the register addresses are provided to the register file, and the source operand data associated with each source register address is read from the register file for use in executing the instruction. Control then passes to block 450, where the instruction is executed, after which control passes back to block 410, where the next instruction in the instruction stream is received.

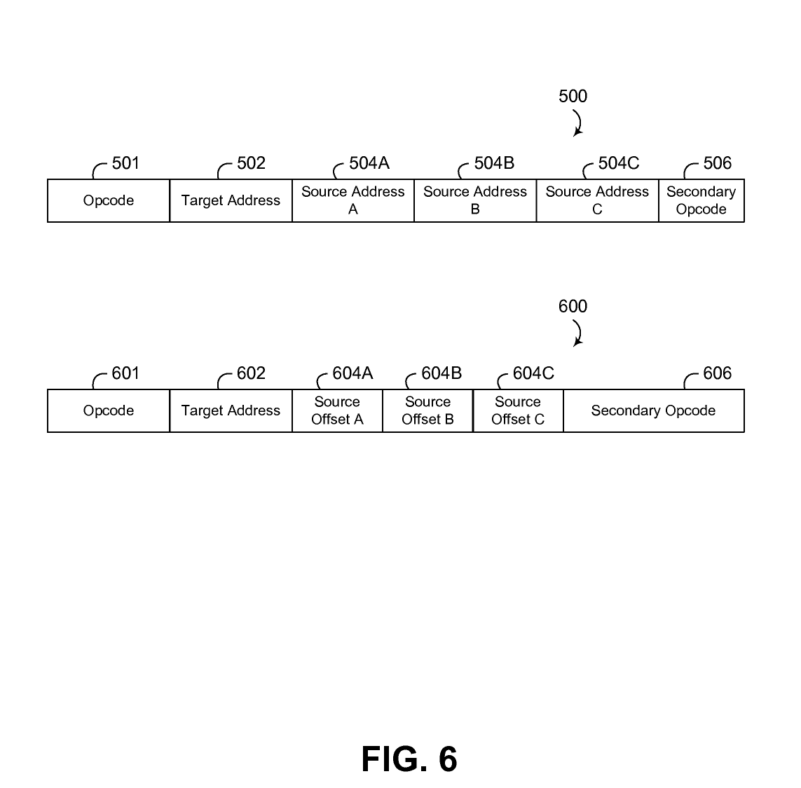

FIG. 6 illustrates at 500 an exemplary instruction format able to be executed by AXU 166. Instruction format 500 contains 32 bits where the bits include an instruction opcode 501 consisting of 6 bits, a 6 bit target address 502, three 6 bit source addresses 504A, 504B and 504C, and a 2 bit secondary opcode 506. As discussed previously, the 2 bit opcode 506 limits the instruction type to only 4 subtypes of operations, yet typically many more are needed.

FIG. 6 also illustrates at 600 an exemplary instruction format supporting register address offset based address indexing and able to be executed by AXU 166 and method 400 consistent with the invention. Instruction format 600 contains 32 bits where the bits include an instruction opcode 601 consisting of 6 bits, a 6 bit target address 602, and three source offsets 604A, 604B, and 604C consisting of 2 bits each. In addition, instruction format 600 contains secondary opcode 606 which is 14 bits. The wider secondary opcode 606 allows for a far greater number of instruction subtypes.

The 2 bit source offsets 604A, 604B and 604C may each be used to be supplied as address offsets 302A, 302B, 302C to the address calculation logic 300 in FIG. 4. In this manner, the source address offsets from the instruction may be used to calculate the desired source addresses to be supplied to register file 304.

Instruction format 600 may contain any number and combination of source address offsets versus full source addresses and not depart from the scope of the invention. For instance, in place of source offset 604A a full 6 bit register address may be used, reducing the number of available bits in the secondary opcode 606 to 10 bits. Opcodes such as opcode 601 and secondary opcode 606 in the instruction specify which source operands in the instruction are referenced by register addresses directly and which are referenced indirectly via an offset. It should be also bet noted that the fixed instruction width may be something other than 32 bits, for instance 64 bits, and not depart from the scope or spirit of the invention.

Embodiments of the present invention may be implemented within the hardware and software environment described above in FIGS. 1-6. However, it will be appreciated by one of ordinary skill in the art having the benefit of the instant disclosure that the invention may be implemented in a multitude of different environments, and that other modifications may be made to the aforementioned hardware and software embodiment without departing from the spirit and scope of the invention. As such, the invention is not limited to the particular hardware and software environment disclosed herein.

Other modifications will be apparent to one of ordinary skill in the art having the benefit of the instant disclosure. Therefore, the invention lies in the claims hereinafter appended.

What is claimed is:

1. A computer system, comprising:
a register file for storing and retrieving operands addressed by register addresses;
an execution unit for executing instructions, the execution unit configured to receive a source operand from the register file and write a result back into the register file;
an address calculation logic configured to receive a base register address and a register address offset to the base register address, and to provide a source register address and a target register address to the register file calculated from the base register address and the register address offset;
an instruction decode logic configured to decode instructions and provide the base register address and the register address offset to the address calculation logic;

2. The computer of claim 1, wherein the address calculation logic comprises an adder configured to add the register address offset with the base register address to yield the source register address;

3. The computer of claim 2, wherein the target register address is obtained directly from the base register address without modification;

4. The computer of claim 1, wherein the address calculation logic comprises an adder configured to add the register address offset with the base register address to yield the target register address;

5. The computer of claim 2, wherein the source register address is obtained directly from the base register address without modification;

6. A method of executing instructions from an instruction set, the method comprising the steps of: receiving an instruction;
determining if an opcode associated with the instruction matches a first instruction type; and
if the opcode associated with the instruction matches the first instruction type, calculating a register address by adding a base register address contained within the instruction with a register address offset contained within the instruction.

7. The method of claim 6, wherein if the opcode associated with the instruction matches the first instruction type, the method further includes the step of: providing the register address to a register file suitable for usage as a source address to execute the instruction.

8. The method of claim 6, wherein if the opcode associated with the instruction matches the first instruction type, the method further includes the step of: providing the register address to a register file suitable for usage as a target address to execute the instruction.
